(19) United States
(12) Patent Application Publication
(10) Pub. No.: US 2026/0220009 A1
(43) Pub. Date: Jul. 30, 2026

(54) SYSTEMS AND METHODS FOR CONFIGURING TESTING SYSTEMS

(71) Applicant: Supernal, LLC, Irvine, CA (US)

(72) Inventors: Andrew Lowery DATKA, Aliso Viejo, CA (US); Cameron NOURI, San Diego, CA (US)

(73) Assignee: Supernal, LLC, Irvine, CA (US)

(21) Appl. No.: 19/141,512

(22) PCT Filed: Dec. 20, 2023
(86) PCT No.: PCT/US2023/085199

§ 371 Date: Jun. 20, 2025

Related U.S. Application Data
(60) Provisional application No. 63/476,582, filed on Dec. 21, 2022.

(51) Int. Cl. G06F 11/26; G06F 11/263

(52) U.S. Cl. CPC G06F 11/261; G06F 11/263

(57) ABSTRACT

A method of configuring a testing system may include receiving, with a switch, a request including an identification of a first test asset of the testing system for testing or a configuration request. The method may also include accessing a current configuration and a current test asset utilization of the testing system, evaluating the current configuration based on the current test asset utilization and the request, determining a test configuration based on the evaluation and an implementation matrix for the testing system, and implementing the switch according to the test configuration. Implementing the switch may include the switch connecting test assets according to the test configuration such that a first test for the first test asset or a configuration according to the configuration request is performed non-exclusively relative to a capability of the testing system to be implemented to test other test assets.

### CROSS REFERENCE TO RELATED APPLICATIONS

This application is the U.S. national phase entry under 35 U.S.C. § 371 of International Application No. PCT/US2023/085199, filed Dec. 20, 2023, which claims priority on U.S. Provisional Application No. 63/476,582, filed Dec. 21, 2022, which is incorporated by reference herein in its entirety.

### TECHNICAL FIELD

The present disclosure relates to systems, devices, and methods for configuring testing systems. More particularly, the present disclosure relates to systems, devices, and methods for configuring testing systems implemented for testing vehicles and vehicles systems, such as testing systems used to test aircrafts and aircraft avionic, flight control, powertrain, actuator, and cockpit systems, devices, computers, and components.

### INTRODUCTION

Testing systems, such as system integration labs, are often used to test both hardware and software incorporated in complex integrated systems for vehicles (e.g., aircrafts, un-manned aircrafts, automobiles, boats, submarines, etc.) as part of the development, and prior to real-world implementations, of those vehicles. A testing system may include complex configurations of workbenches (also known as test benches), which may include as many pieces of hardware of a sub-system of a vehicle that can feasibly be included in a lab environment.

In workbenches, hardware and other types of components (e.g., software packages for hardware components) may define line replaceable units (“LRUs”). In addition, workbenches may include LRUs interconnected with LRUs of other workbenches. In the context of aircrafts, this may include, for example, an LRU such as an aircraft management computer (AMC) of an avionics workbench, interconnected with an LRU of another workbench, such as a flight control system (FCS) on a flight control bench or an actuator or actuation system of an actuation bench. Complex configurations of interconnected workbenches may enable a testing system to tie together, and test all at once, groups of systems or strings of interconnected LRUs that may be incorporated in a control system being developed for a vehicle.

In the context of testing systems described herein, workbenches and LRUs may provide or otherwise define test assets of the testing system. However, testing involving LRUs of one workbench or interconnected workbenches can require all other parts of a testing system to be locked down. Having to lockdown an entire lab to test the functionality of one LRU (one test asset) is not efficient and does not allow for maximum utilization of lab capability. In fact, entire teams of engineers may be prevented from working simultaneously because any test run specific to one engineering team likely requires a lockdown of an entire testing system. A work around for this issue may involve creating deconfliction schedules where only one engineering team out of several can use a testing system. Alternatively, a standalone workbench may be built to test the single LRU, but more often than not this is a prohibitive proposition from cost, time, and/or required labor standpoints.

In addition, lab architecture redesigns are typically required to integrate additional individual systems into existing testing systems. This may require lab operators (e.g., engineers) to physically unplug and plug in connectors when changing lab components. Physical reconnections can take hours or days to execute, and are accompanied by a substantial risk of human error. In addition, a common method used by engineers to test new installations of new systems, devices, or components in many technology areas, may not be available in the context of a testing system corresponding to a vehicle. That is, a lab operator may be unable to use a method that includes testing software supporting a new LRU first, then testing the LRU by itself, and then testing the LRU and one other LRU together to verify an integration therebetween. Instead, after there has been a change to the lab, an arduous and time and labor intensive type of quality assurance process (also known as “a system checkout”) may be performed to ensure: (A) that no errors were made in the change process, and (B) the reliability of tests run after there has been a change. Such quality assurance processes may largely involve manual processes and require days or weeks to perform.

The present disclosure is directed to overcoming one or more of these above-referenced challenges.

### SUMMARY OF THE DISCLOSURE

Examples described herein include devices, systems, and methods for configuring test systems. In one embodiment, a method of configuring a testing system may include receiving, with a switch, a request including an identification of a first test asset of the testing system for testing or a configuration request. The method may also include accessing a current configuration and a current test asset utilization of the testing system, evaluating the current configuration based on the current test asset utilization and the request, determining a test configuration based on the evaluation and an implementation matrix for the testing system, and implementing the switch according to the test configuration. In one embodiment, implementing the switch may include the switch connecting test assets according to the test configuration such that a first test for the first test asset or a configuration according to the configuration request is performed non-exclusively relative to a capability of the testing system to be implemented to test other test assets.

Various aspects of exemplary switches and methods implementing switches according to the present disclosure may include one or more of the following features: an implementation matrix may include a misconfiguration specific to the testing system and which may specify at least two test assets of the testing system that cannot be operably coupled; an implementation matrix including a utilization scheme specifying at least two test assets that may be operably coupled by more than one series of operably coupled test assets; a method that includes modifying a test configuration with a switch to include a simulation of hardware of at least one test asset in the test configuration based on a current utilization of the hardware; a method that includes implementing a first test for a test asset of a request with a switch, and implementing a second test for a second test asset with the switch at the same time as the first test; a first test asset including a system of test assets; a first test asset being a single line replaceable unit included in a system of test assets that are incorporated in an actuation workbench or a powertrain workbench, and a first test that includes configuring the first test asset to be disconnected from the system of test assets; a test of an asset including stand-alone testing of the test asset; and a first test includes connecting a first test asset to a second test asset not included in the system of assets.

Various additional aspects of exemplary methods described herein may include: a method including determining a configuration of a configuration request corresponds to a misconfiguration included in an implementation matrix, issuing a notification that the configuration is invalid, and displaying the notification with a computing device; a locking down a second test asset of a test system and implementing a first test of the first test asset, with the first test asset and the second test asset being incorporated in a first workbench; implementing a second test of a third test asset incorporated in a first workbench during at least part of an implementing of a first test of a first test asset; and a testing system corresponding to an aircraft, and test assets of the testing system including an avionics workbench, a flight controls system workbench, and a powertrain workbench.

Examples described herein include a testing system that may correspond to a vehicle, and may include a plurality of workbenches, each workbench incorporating at least two test assets, and a switch operably coupled to the plurality of workbenches. In one example the switch may include a plurality of ports connected to the plurality of workbenches, one or more processors, and one or more computer readable media comprising instructions which, when executed by the one or more processors, cause the one or more processors to perform operations. In various examples described herein, the operations may include receiving, with a switch, a request including one of an identification of a first test asset of the testing system for testing and a configuration request, accessing a current configuration and a current test asset utilization of the testing system, evaluating the current configuration based on the current test asset utilization and the request, determining a test configuration based on the evaluation and an implementation matrix for the testing system, implementing the switch according to the test configuration, and tracking changes to a current configuration of the testing. Various aspects of exemplary testing systems as described herein may include operations that include: accessing a plurality of workbenches, identifying misconfigurations between test assets of a testing system, and incorporating the misconfigurations in an implementation matrix; identifying utilization schemes for connecting test assets across a plurality of workbenches, such that each of the utilization schemes may specify at least two test assets of a testing system that may be operably coupled by more than one series of operably coupled test assets; modifying, with a switch, a test configuration to include a simulation of hardware of at least one test asset in a test configuration based on a current utilization of the hardware; and locking down a second test asset of a test system and implementing a first test of the first test asset, such that first test asset and the second test asset are incorporated in a first workbench of the plurality of workbenches.

Examples described herein include an exemplary switch with a plurality of ports, one or more processors, and one or more computer readable media comprising instructions. In various examples of the present disclosure the instructions, when executed by the one or more processors, may cause the one or more processors to perform operations of receiving a request including one of an identification of a first test asset of the testing system for testing and a configuration request, accessing a current configuration and a current test asset utilization of the testing system, evaluating the current configuration based on the current test asset utilization and the request, determining a test configuration based on the evaluation and an implementation matrix for the testing system, operating according to the test configuration, and modifying the test configuration to include a simulation of hardware of at least one test asset in the test configuration based on a current utilization of the hardware.

Various aspects of exemplary switches described herein may include a plurality of ports for the switch including at two of an Ethernet port, an RS-485 port, a CAN port, and an RS-422 port.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary testing system for performing vehicle testing, according to one embodiment.

FIG. 2 depicts a flowchart of an example method for building or generating an implementation matrix, according to one embodiment.

FIG. 3 depicts a flowchart of an example method for determining or generating a test configuration for a testing system, according to one embodiment.

FIG. 4 depicts a sequence diagram of an example method for configuring a testing system according to a test configuration, according to one embodiment.

FIG. 5 depicts a sequence diagram of an example method for managing data for a testing system that includes test configuration-related information, according to one embodiment.

FIG. 6 depicts a flowchart of an example method for adding a test asset to a testing system, according to one embodiment.

FIG. 7 depicts exemplary system components of a testing system for vehicles, such as aircrafts, according to one embodiment.

FIG. 8 depicts an example graphical user interface (“GUI”) for a testing system that may be used to perform the various methods described herein.

FIGS. 9A-9G depict an example GUI for a testing system that may be used to perform the various methods described herein.

### DETAILED DESCRIPTION OF EMBODIMENTS

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Various embodiments of the present disclosure relate generally to exemplary switches and methods of implementing those switches to enable a test lab environment to adapt to changing test needs without physical reconfiguration of the lab. All individual systems of a vehicle corresponding to the single lab may be connected to an exemplary switch of the present disclosure. This switch may have physical connections that are found on a real version of a vehicle, including Ethernet, controller area network (“CAN”), RS-422, RS-485, or any other data buses required. The switch may implement one or more services that may configure what workbenches are connected to each other to best fit testing purposes and allow for maximum utilization of the lab. This may include individual asset testing, which traditionally require the purchase of a standalone test setup, and/or system of systems testing.

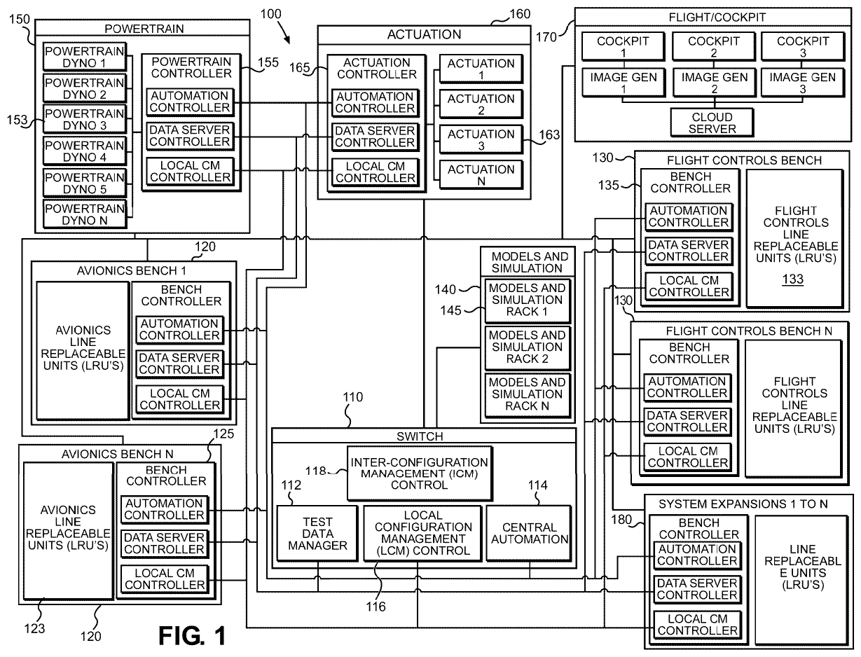

FIG. 1 depicts an exemplary testing system 100 for performing vehicle testing, according to one embodiment. In one embodiment, the testing system may provide a system integration lab (“SIL”) for testing components of a vehicle, such as an aircraft. In one example, with avionics, flight control, powertrain, actuation, and flight/cockpit workbenches 120, 130, 150, 160, 170, the testing system 100 may include a substantial amount of actual physical hardware from the vehicle that may be provided in a simulated environment. The testing system 100 may further include a switch 110 that is connected to the avionics, flight control, powertrain, actuation, and flight/cockpit workbenches 120, 130, 150, 160, 170. In addition, the switch 110 may be connected to a models and simulation system 140.

In general, the avionics workbench 120 contains anything related to mission management within a vehicle corresponding to the testing system 100. In one example, the avionics workbench 120 may be responsible for waypoint navigation as well as receiving and processing sensor data. From a component standpoint, first LRUs 123 for the avionics workbench 120 may include one or more of an aircraft management computer (“AMC”), as well as various sensors and navigation equipment installed on an actual aircraft corresponding to the testing system 100.

The flight controls workbench 130 may include second LRUs 133 corresponding to computing devices (e.g., flight control system (“FCS”)) associated with controlling an aircraft defining a vehicle corresponding to the testing system 100. Thus, should a test involve an action corresponding to a pilot pushing a stick left, the second LRUs 133 of the flight controls bench 130 correspond to those components that are responsible for directing actions by the aircraft needed for the aircraft perform a left turn.

Turning to the powertrain workbench 150, third LRUs 153 for this workbench may include dynos, which may be electrical equivalents to components of an engine found on an aircraft or other type of vehicle corresponding to the testing system 100. In one example, the third LRUs 153 may correspond to those components responsible for causing an aircraft defining a vehicle corresponding to the testing system 100 to move (e.g., driving a plane up and forward). In addition, actuators or actuation systems 163 of the actuation workbench 160, may encompass flaps found throughout an aircraft that defines a vehicle that corresponds to the testing system 100.

FIG. 1 also depicts a connection between the switch 110 and a representation of a possible system expansion 180 of the testing system 100. This may include workbenches that correspond to new components or systems (e.g., supplemental electric drive system, additional types of rotors, or landing gear) that may be incorporated in a vehicle corresponding to the testing system 100 (or new iteration thereof). As discussed below, one advantage of the systems, devices, and methods described herein, is the ease with which a testing system can be expanded and potentially tested, without having to lock down the rest of that testing system.

One of ordinary skill in the art will recognize that the system expansion 180 depicted in FIG. 1 may not be limited in type or number to one additional system, component, or workbench. One of ordinary skill will further recognize that the system expansion is not limited to known systems, components, or workbenches, but includes yet to be developed systems, components, or workbenches for a vehicle corresponding to the testing system 100.

As described herein, each of the first and second LRUs 123,133, the dynos 153, the actuators or actuation systems 163, or the flight/cockpit components 173 may be considered a test asset within the testing system 100. In addition, each of the avionics, flight control, powertrain, actuation, and flight/cockpit workbenches 120, 130, 150, 160, 170 may be considered a test asset. The switch 110 provides a flexibility to connect with, and make different interconnections between, these different test assets. Further the switch provides a capability to facilitate simultaneous testing of: (1) multiple test assets in isolation; (2) a test asset in isolation and a system of test assets; and (3) multiple systems of test assets.

The switch 110 may include a plurality of ports configured to connect to different types of cables (Ethernet cables, coax cables) configured for different communication protocols (e.g., Ethernet, CAN, RS-422, RS-485), as well as receive wireless signals of different communication protocols (WiFi, Bluetooth, NFC, Zigbee, etc.). In one example, the switch 110 may include a plurality of switches (e.g., Ethernet switches) associated with ports to which different cables are connected or different wireless signals are received thereby. The switch may be configured to recognize identifiers of one or more types (e.g., IP address, MAC address, or other proprietary LRU identification protocols) for the plurality of switches and route information between, or otherwise connect, different switches from the plurality of switches together, using the identifiers. In one example, the switch 110 may include a plurality of switches (e.g., Ethernet switches), such that multiple networks of switches may be provided within the switch 110.

In one embodiment the switch 110 may include a test data manager 112, a central automation module 114, a local configuration management (“LCM”) control 116, and an inter-configuration management (“ICM”) control 118. In one embodiment, each of the avionics, flight control, powertrain, actuation, and flight/cockpit workbenches 120, 130, 150, 160, 170 may include a data server controller as part of a respective bench, powertrain, and actuation controller 125, 135, 155, 165. The test data manager 112 may be configured to connect to, communicate with, or otherwise receive information from these data server controllers. The test data manager 112 may include a server or group of servers connected to the switch 110. In another embodiment the test data manager 112 may be a connection between the switch 110 and a server or group of servers. The test data manager 112 either stores or routes for storage, test results from implementations of the testing system 100 as provided from the data server controllers 125, 135, 155, 165.

The central automation module may include a computing device that is integrated within or connected externally to the switch 114, and may govern any test automation performed by the testing system 100. In one example, certain tests may be initiated through, and possibly consist of, direct user action with respect the testing system 100 and one of the workbenches therein. In other examples, tests implemented by the testing system may be automated pursuant to management, initiation, or other types of directions communicated by the switch 114 to an automation controller of a bench, powertrain, and/or actuation controller 125, 135, 155, 165.

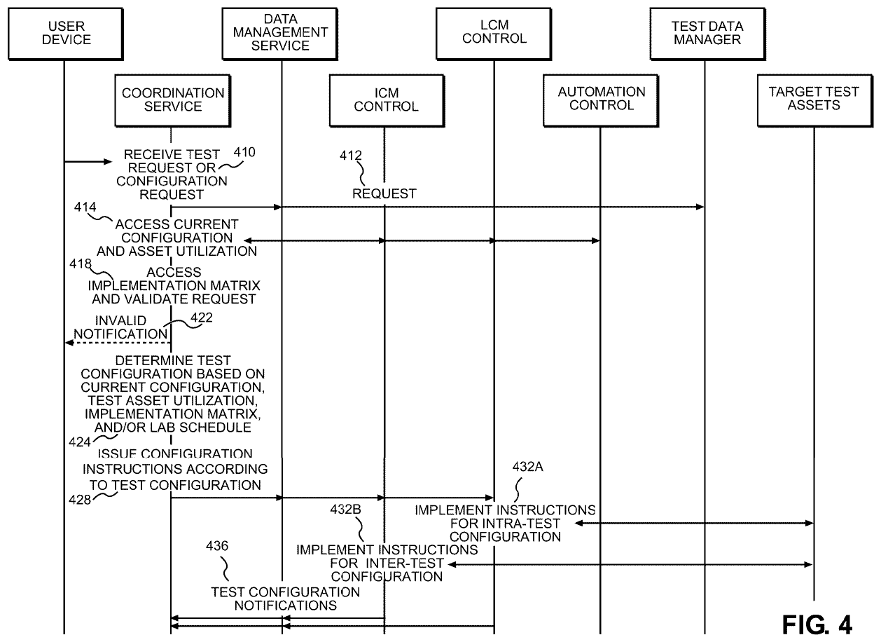

The LCM control 116 may direct local configuration management (“CM”) controllers to implement, record, and provide for recording/storing by the LCM control 116, information regarding configurations of test assets of individual workbenches. On the other hand, the ICM control 118 may direct workbench controllers 125, 1325, 155, 165, 175, to implement, record, and provide for recording by the ICM control 118, information regarding configurations of test assets connected between workbenches, as well as connections between the subject workbenches. Aspects of LCM and ICM controls such as the LCM and ICM controls depicted in FIG. 1 are provided in more detail with reference to FIG. 4.

In addition to being physically or otherwise operably coupled to the avionics, flight controls, powertrain, actuation, and flight/cockpit workbenches 120, 130, 150, 160, 170, the switch 110 may be connected to a models and simulation system 140. According to the present disclosure, the testing system 100, and particularly the switch 110, may enable simultaneous isolated testing of a multiple test assets. In situations where multiple test assets being isolated and tested are connected to another test asset (a common test asset) on the same or different workbench, the models and simulation system 140 may be utilized by the switch to simulate the common test asset for one of the isolated test assets while other test asset is tested as connected to the actual common test asset.

As noted above, each of the first and second LRUs 123,133, the dynos 153, the actuators or actuation systems 163, or the flight/cockpit components 173 may be considered a test asset within the testing system 100. A primary advantage of systems, devices, and methods described herein is a capability to non-exclusively test these test assets (and yet to be developed test assets) for respective fitness to correctly or otherwise sufficiently perform a functional, mechanical, or otherwise operational process for which that test asset is intended to perform.

As used herein with respect to testing systems, switches, and test assets of the present disclosure, “non-exclusively” may correspond to a capability to test one test asset in isolation from other test assets in a string or system of test assets that includes that one test asset. Absent systems, devices, and methods described herein, such a string or system of test assets may normally have to be tested as a whole as a means for testing any constituent test assets. Thus, “non-exclusively” may encompass the features of a test of one test asset does not require testing all other test assets in a respective string or system.

Separately from or in addition to the capability described immediately above, “non-exclusively” may correspond to a capability to test one test asset in isolation, without requiring a lockdown of remaining test assets incorporated in a string including the one test asset or generally any other test asset included in a testing system. Thus, systems, devices, and methods described herein enable testing of a test asset in isolation while: (1) other test assets of a respective or other system of test assets are tested in isolation; and/or (2) other systems of test assets are tested as they normally be tested as systems; and/or (3) user defined systems of test assets are tested.

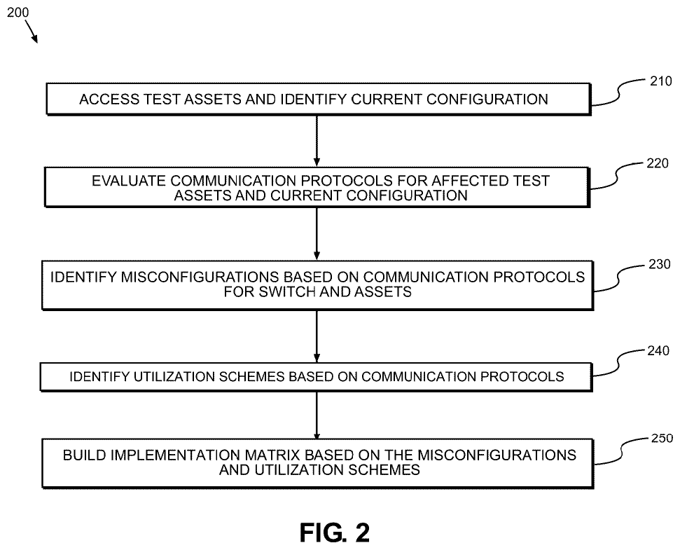

FIG. 2 depicts a flowchart 200 of an example method for building or generating an implementation matrix, according to one embodiment.

At 210, a switch, such as the exemplary switch 110 depicted in FIG. 1, may access test assets incorporated in a testing system, such as the exemplary testing system 100 also depicted in FIG. 1, and identify a current configuration of connections between test assets. In one embodiment, this may include the switch polling an ICM control such as the ICM 118, an LCM control such as the LCM 114, or CM controllers, such as the exemplary CM controllers depicted in FIG. 1, to obtain connection and LRU-related information.

At 220, a switch may evaluate communication protocols for test assets in the current configuration identified at 210. In particular, the switch may access LRU-related information, such as corresponding physical component and/or computing device information, from a workbench controller, such as the controllers 125, 135, 155, 165 depicted in FIG. 1. Information requests from the switch to the controllers may specify a communication protocol as the information sought. The switch may complete this polling of communication protocol information for all test assets in a testing system.

Evaluation of the communication protocols may include identifying communication protocols currently in use between test assets for the current configuration. This may be managed through an individual, or series of, matrices or databases loaded to the switch, as a source of truth data. In one example, evaluation of the communication protocols may include identifying type and requirements for connection to different data buses included in workbenches of a testing system.

It is at 220, where a switch may build a base of information regarding types of cables that are connected to various ports of the switch and what types of wireless signals, if any, any of these ports are receiving. In one embodiment, the switch may determine the different types of data buses employed by various other components of the testing system, such as workbenches. The data bus information may be applied by the switch to determine the different interfaces (e.g., cable connections) employed in the testing system and to configure the switch to maintain separation between these interfaces in order to drive switching there between and switching more generally between different data buses.

At 230, a switch may identify misconfigurations based on communication protocols for the switch and test assets. In one example, a misconfiguration may include the specification of a connection between two test assets that is not compatible from operational and/or communication protocol stand points. Identification of these misconfigurations may be utilized by a switch to determine and communicate that a requested configuration is invalid and cannot be implemented.

At 240, a switch may identify utilization configurations based on the communication protocols. In one example, a utilization configuration may include a specification for an alternative connection scheme between two or more test assets currently connected in the current configuration. In another example, at 240, the switch may determine there are one or more groups of two or more tests assets that are connected to or otherwise dependent on a common test asset for testing and operational purposes. In turn, the switch may determine which of the connections between the test assets and common test assets may be simulated using a models and simulation system, such as the models and simulation system 140 depicted in FIG. 1. In turn, this information may be incorporated into and implementation matrix as a utilization scheme at 250.

At 250, an implementation matrix may be built or otherwise created based on the communication protocol information for the test assets, the misconfigurations identified at 230, and the utilization schemes identified at 240. In one embodiment, the implementation matrix may include a type of lookup table that specifies all misconfigurations, standard configurations, and utilization schemes applicable to each test asset of a testing system.

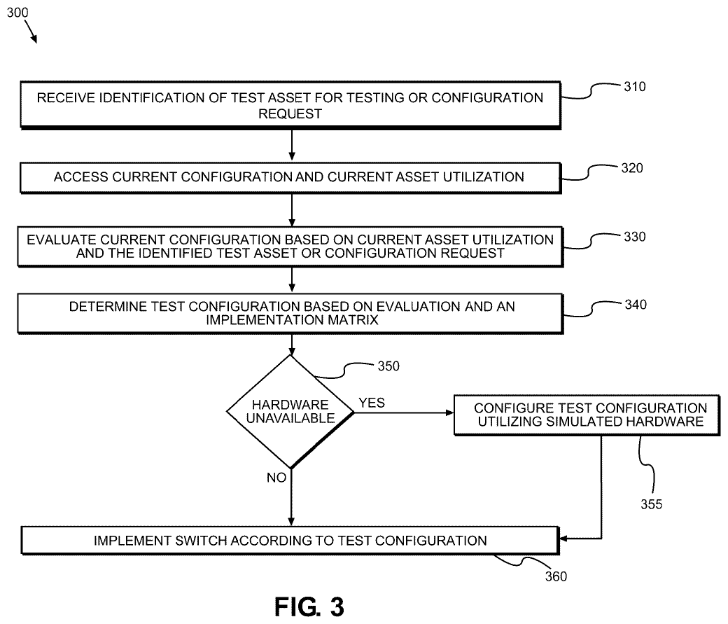

FIG. 3 depicts a flowchart of an example method 300 for determining or generating a test configuration for a testing system.

At 310, a switch may receive an identification of a test asset(s) for testing, or a configuration request that specifies a configuration of a testing system that may be desired by a user (e.g., lab operator, engineer) or needed by another switch, workbench or other types of test asset. In one example the test asset may be selected and input with a computing device by, for example, a lab operator. Further, the test asset identification received at 310 may specify a type of test to be run and any hardware, if any, that may be involved. On the other hand, a configuration request may, for example, specify changing a connection between two test assets so that one of the tests may be tested in an isolated stand-alone manner. In another example, the configuration request may specify connecting: previously disconnected test assets.

At 320, a switch may access a current configuration and a current asset utilization. Accessing the current configuration may include similar processes described for the method depicted in FIG. 2 at 210. In other examples, the switch may utilize a data management service to access current configuration information obtained: (1) from an earlier determination of a then-current configuration, or (2) subsequent to a last test implementation for a testing system including the switch.

In addition to a current configuration, current utilizations of test assets may be obtained at 320. In one example, this may include identifying all test assets that are currently being tested and those not being tested, including a test asset specified at 320 or test assets affected by a resulting configuration for the configuration request. As noted above, the systems, devices, and methods described herein enable simultaneous but separate testing of different test assets provided in stand-alone configurations and/or as part systems or strings of assets. As discussed below, the current asset utilization may be used to determine if a test asset or configuration request specified at 310 can or must be completed at the same time another test or configuration of one more tests is completed.

At 330, a switch may evaluate a current configuration based on a current asset utilization and a test asset identified or configuration requested at 310. More specifically, the switch may determine whether or not a modification to the current configuration is required to test an identified test asset or configuration requested at 310.

At 340, a determination may be made for a test configuration based on the evaluation at 330 and the implementation matrix. More specifically, in one example, the evaluation may specify that the current configuration is not useable a testing system to perform a test of an identified test asset or is different from a configuration specified in the configuration request at 310. The implementation matrix may be accessed by a switch in this situation in order to identify any utilization schemes that may be implemented to satisfy the identification or request received at 310.

In one example, the test configuration determined at 340 may specify a configuration that may captures an improved, near-optimal, or optimal utilization of all test assets of a testing system. This includes not locking down the testing system in order to test one test asset or implement a configuration of a configuration request.

At 350, a switch may poll test assets included in a test configuration determined at 340 to take inventory of which of these test assets include hardware, and determine if that hardware is or will be available to implement the test configuration. In addition, the switch may perform the same evaluation for test assets that include hardware and are included in potential alternative test configurations using different utilization schemes. In one example, the switch may poll workbenches including the hardware incorporating test assets or access the implementation matrix and look up this information.

Hardware for test assets involved in the test configuration may be determined to be unavailable at 350, and a switch may be configured to modify the test configuration at 355 to utilize simulated hardware for the unavailable hardware.

For example, referring back to FIG. 1, a team of powertrain engineers may want to perform one or more standalone tests involving one or more powertrain dynos 153 incorporated in the powertrain workbench 150. Certain avionics LRUs 123 incorporated in one of the avionics workbenches 120 may depend on the one or more powertrain dynos 153 and be part of certain tests an avionics team wants to conduct. Alternatively, the certain avionics LRUs 123 may be the subject of stand-alone tests the avionics team wants to conduct on those LRUs 123. Likewise, certain flight control LRUs 133 may depend on the one or more powertrain dynos 153 and be part of certain tests that a controls team wants to conduct. Alternatively, the certain flight control LRUs 133 may be the subject of stand-alone tests that a controls team wants to conduct on those LRUs 133.

For the example described immediately above, an exemplary switch according to the present disclosure may be implemented according to a test configuration generated with an execution of the exemplary method depicted in FIG. 3. Such an implementation may involve the switch disconnecting the powertrain workbench 150 from the subject avionics and flight control workbenches 120, 130. Furthermore, such an implementation may include the switch connecting avionics and flight control workbenches 120, 130 to a simulation rack that includes whatever simulations are needed to run or conduct stand-alone tests involving the avionics or flight control LRUs 123, 133. In turn, an ability to simultaneously test the avionics or flight control LRUs 123, 133 may be preserved without requiring physical disconnections and reconnections of cables associated with the workbenches and LRUs referenced above for the purposes of this example. Thus exemplary switches according to the present disclosure may, as a fundamental function thereof, complete all network configuring between workbenches to make stand-alone tests for specific LRU's executable without having to make changes to physical connections between the workbenches.

Once the modification to the test configuration is specified at 355, or it is determined at 350 all hardware associated with an original test configuration is available, a switch may be implemented at 360 according the test configuration to complete a configuration that may be implemented to: test an identified test asset; or configure a testing system according to a configuration specified in a configuration request at 310.

FIG. 4 depicts a sequence diagram of an example method for configuring a testing system according to a test configuration, according to one embodiment.

At 410, a coordination service may receive a request for testing a certain test asset in a testing system or a request for configuring a testing system according to a specified configuration. In the case of a request for testing a test asset, a test asset of the request may be one or more individual test assets, one or more workbenches, or system of test assets may be identified being tested. On the other hand, in the case of a request for a configuration, the request may specify a configuration of test assets and/or workbenches for implementation. At 412, the coordination service may transmit the request to a data management service and a test data manager of an exemplary switch of the present disclosure.

In one example, each of the coordination service, data management service, ICM control, and LCM control may be constituted by or comprise an application or agent running, or otherwise being implemented on a switch by, for example, a processor of the switch. In addition, each of the coordination and data management services may be an application or agent that may be part of, or configured to be compatible with, a software product that is installed on or at least partially provided by the processor of an exemplary switch according to the present disclosure. The software product can provide tools for generating an implementation matrix, identifying misconfigurations and utilization schemes, data conversion and formatting, generating components and/or selectable options of a user interface (“UI”), such as a graphical user interface, supporting selections made through a UI, and any other relevant features.

The test data manager may be similar to or a version of the test data manager 112 of the testing system 100 depicted in FIG. 1. Accordingly the test data manager depicted in FIG. 4 may be configured to connect to, communicate with, or otherwise receive information from data server controllers operating within workbenches of a testing system. Further, the test data manager may include a server or group of servers connected to a respective switch, or constituted by a connection between the switch and a server or group of servers. The test data manager of FIG. 4 may store or route for storage, test results from implementations of a testing system.

In one example the request may be transmitted to the test data manager at 410 so that the request may later be associated with test results coming from a test of the test asset identified in the request. Likewise the test request may be transmitted to the data management service so that it may be later associated with a test configuration used in conducting a test or implementing a configuration specified in the request.

At 414, the coordination service may access a current configuration and current asset utilization of a testing system including a switch implementing the coordination service. As at 320 of the exemplary method depicted in FIG. 3, the coordination service may poll an ICM control, an LCM control, and/or CM controllers to obtain connection and LRU-related information for test assets of a testing system. In other examples, the coordination service may utilize, request, or direct the data management service to access current configuration information maintained by the data management service. In one embodiment, the current configuration information transmitted by the data management service may have been obtained: (1) from an earlier determination of a then-current configuration, or (2) subsequent to a last test implementation for the testing system including a switch.

At 418, the coordination service may access an implementation matrix for a testing system including a switch that received the request at 410. In one example, the coordination service may access misconfiguration and utilization scheme information incorporated in the implementation matrix and validate the request.

In one embodiment, validation at 418 may include determining that the request does not correspond to any misconfiguration represented by information included in the implementation matrix.

In another embodiment, validation at 418 may include the coordination service using the implementation matrix to determine the request corresponds to at least one of a current configuration, a standard configuration excluding any simulations for hardware, or a configuration defined by one or more utilization schemes.

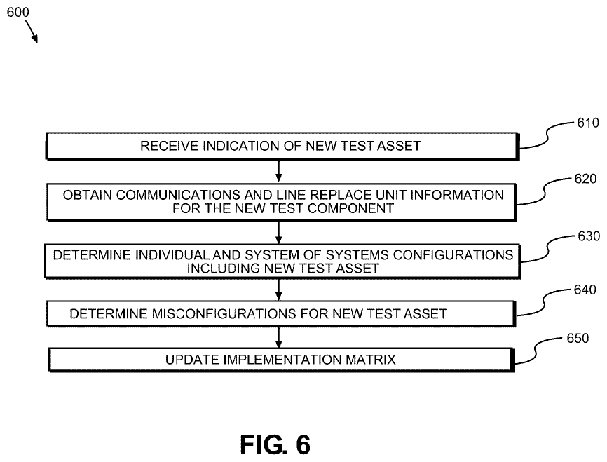

In still another embodiment, a request may be validated at 418 upon the coordination service determining:
the request does not correspond to a misconfiguration but does correspond with a current, standard, or utilization scheme configuration;
the request does correspond to a misconfiguration but can be substituted for the purposes of testing or fulfilling a configuration request using a configuration of a utilization scheme;
does not correspond to a misconfiguration but does involve hardware currently being utilized to perform a test or fulfill a different request (meaning testing for another test asset is currently being done but the rest of the testing system is not locked down so other testing can be completed), but an equivalent of that hardware can be provided by a models and simulation service; or
does not correspond to a misconfiguration, a current configuration, a standard configuration, or a configuration as defined by a utilization scheme, as may be the case where a new test asset, system of test assets, or workbench is added to a testing system, in which case a process such at the exemplary method depicted in FIG. 6 and described hereafter, may be implemented.

On the other hand, if the request cannot be reconciled with any of the situations described immediately above, the coordination service may cause a notification that the request is not valid be generated and conveyed to the user device at 422. In turn, the user device may display or otherwise communicate the notification to a user such as a lab operator or engineer, other switch, or test asset.

At 424, the coordination service may determine a test configuration based on a current configuration (as accessed at 414), current test asset utilization, and/or an implementation matrix (as accessed at 418) similar to processes of the exemplary method of FIG. 3 at 340. In addition, the coordination service may determine the test configuration based on a lab schedule. Exemplary switches according to the present disclosure may enable a team of engineers to test and integrate on a system or sub-system of a testing system without impacting other teams and those team's activities with the system, the same subsystem, or a different subsystem. This may allow those other teams to test and systems/subsystems to be tested at the same time that the engineers test and integrate test assets, sub-systems, and systems that team normally interacts with. Table 1 provided below provide an example testing system schedule broken into engineering team schedules relative to subsystems (e.g., workbenches).

TABLE 1
Engineering Team Schedule for Working with a Testing System

| | | MISSION | TEST & | VEHICLE | POWER | FLIGHT |
|---|---|---|---|---|---|---|
| TIME | SYSTEM | MNGMT | EVAL (TE) | MNGMT | TRAIN (PT) | TECH (FT) |
| 8:00 AM | FLIGHT CON. SYS. (FCS) | | [symbol] | | [symbol] | [symbol] |
| | POWERTRAIN (PT) | | [symbol] | | [symbol] | |
| | AVIONICS (AV) | | [symbol] | [symbol] | [symbol] | |
| | COCKPIT (CP) | | [symbol] | | [symbol] | |
| | ACTUATION (ACT) | | [symbol] | | [symbol] | |
| 9:00 AM | FCS | [symbol] | [symbol] | | [symbol] | [symbol] |
| | PT | | [symbol] | | [symbol] | |
| | AV | [symbol] | [symbol] | [symbol] | [symbol] | |
| | CP | | [symbol] | | [symbol] | |
| | ACT | | [symbol] | | [symbol] | |
| 10:00 AM | FCS | [symbol] | [symbol] | | [symbol] | [symbol] |
| | PT | | [symbol] | | [symbol] | |
| | AV | [symbol] | [symbol] | | [symbol] | |
| | CP | | [symbol] | | [symbol] | |
| | ACT | | [symbol] | | [symbol] | |
| 11:00 AM | FCS | [symbol] | [symbol] | | [symbol] | [symbol] |
| | PT | | [symbol] | | [symbol] | |
| | AV | [symbol] | [symbol] | | [symbol] | |
| | CP | | [symbol] | | [symbol] | |
| | ACT | | [symbol] | | [symbol] | |
| 12:00 AM | FCS | | [symbol] | | [symbol] | [symbol] |
| | PT | | [symbol] | | [symbol] | |
| | AV | | [symbol] | | [symbol] | |
| | CP | | [symbol] | | [symbol] | |
| | ACT | | [symbol] | | [symbol] | |
| 1:00 PM | FCS | | [symbol] | | [symbol] | [symbol] |
| | PT | | [symbol] | | [symbol] | |
| | AV | | [symbol] | | [symbol] | |
| | CP | | [symbol] | | [symbol] | |
| | ACT | | [symbol] | | [symbol] | |
| 2:00 AM | FCS | | [symbol] | | [symbol] | [symbol] |
| | PT | | [symbol] | | [symbol] | |
| | AV | | [symbol] | | [symbol] | |
| | CP | | [symbol] | | [symbol] | |
| | ACT | | [symbol] | | [symbol] | |
| 3:00 AM | FCS | [symbol] | [symbol] | | | [symbol] |
| | PT | | [symbol] | | | |
| | AV | [symbol] | [symbol] | [symbol] | | |
| | CP | | [symbol] | | | |
| | ACT | | [symbol] | | | |
| 4:00 AM | FCS | | [symbol] | | | [symbol] |
| | PT | | [symbol] | | | |
| | AV | | [symbol] | [symbol] | | |
| | CP | | [symbol] | | | |
| | ACT | | [symbol] | | | |
| 5:00 AM | FCS | | [symbol] | | | [symbol] |
| | PT | | [symbol] | | | |
| | AV | | [symbol] | [symbol] | | |
| | CP | | [symbol] | | | |
| | ACT | | [symbol] | | | |

As one of ordinary skill in the art may glean from the information provided in Table 1, systems, devices, and methods of the present disclosure, in particular the exemplary switches described herein, enable multiple engineering teams to use, test, and modify similar test assets at the same time through the utilization of different configurations of those similar test assets. This is in significant contrast to testing systems that do not include a switch according to the present disclosure and therefore lack the level of flexibility such a switch provides. Instead, in those test systems lacking a switch, testing a single test asset requires testing, or at least lockdown of, an entire workbench or string of test assets that include the single test asset, and furthermore requires the lock down of all other test assets (workbenches, strings of test assets, and any other test assets that are not incorporated in a standalone workbench) of the testing system. As a result, instead of five engineering teams working with a testing system in the same hour, like the testing system represented by Table 1 at 9:00 AM, only one team would be able to run tests and work with a testing system that was not, at the very least, provided with any of the exemplary switches of the present disclosure.

At 428, the coordination service may issue configuration instructions for configuring a testing system according to the test configuration determined at 422. This may include transmitting the test configuration, as well as the configuration instructions, to the data management service, an LCM control, and an ICM control.

Upon receipt of the instructions, the data management service may associate these instructions and the test configuration, in addition to test results later generated from an implementation of the test configuration, with a test asset(s) to be tested. In addition, the data management service may associate with the test configuration, the test asset and test results, along with test results from any subsequent tests implementing the test configuration with respect other test assets.

At 432A, an LCM control may implement an intra-test configuration portion of the configuration instructions issued at 428. Likewise, at 432A, an ICM control may implement an inter-test configuration portion of the instructions issued at 428.

In one example, implementation of instructions at 432A and 432B, may include the LCM and ICM controls tracking implementations of respective portions of a test configuration until fully implemented. This may include communicating on repetitive basis with local CM controllers of workbenches including test assets that are included in or otherwise affected by the implementation of the test configuration. This may include checking the progress and correctness of configurations being implemented relative to the test configuration as defined by the coordination service. In another example, implementation of instructions at 432A and 432B, may include tracking and recording every aspect of implementation of respective portions of a test configuration.

In still another example, implementation of instructions at 432A and 432B, may include the LCM and ICM controls directing bench controls to make the connections or disconnections between test assets and workbenches (in the case of the ICM control) needed to provide a test configuration.

Accordingly, processes and methods performed at 432A and 432B may reduce a need for, lessen an amount labor required by, or replace in whole or in part, a quality assurance test such as a system checkout. Such quality assurance processes mentioned above may require physically locking down all or part of a testing system, and a team of engineers preforming a formal test to make sure test results are 100% accurate from a from a hardware and software perspective. This may involve engineers going line by line through entire installation documents and test result reports to make sure that everything was installed exactly as specified in the installation document (e.g., every cable was put together exactly as specified). Following a four month test campaign, a quality assurance process can take two to three weeks in which a testing system is locked down, and if one LRU or other test specification is found be incorrect, an entire four month test can be invalidated.

At 436, the ICM and LCM controls may transmit a notification to the coordination service that respective portions of the test configuration have been implemented.

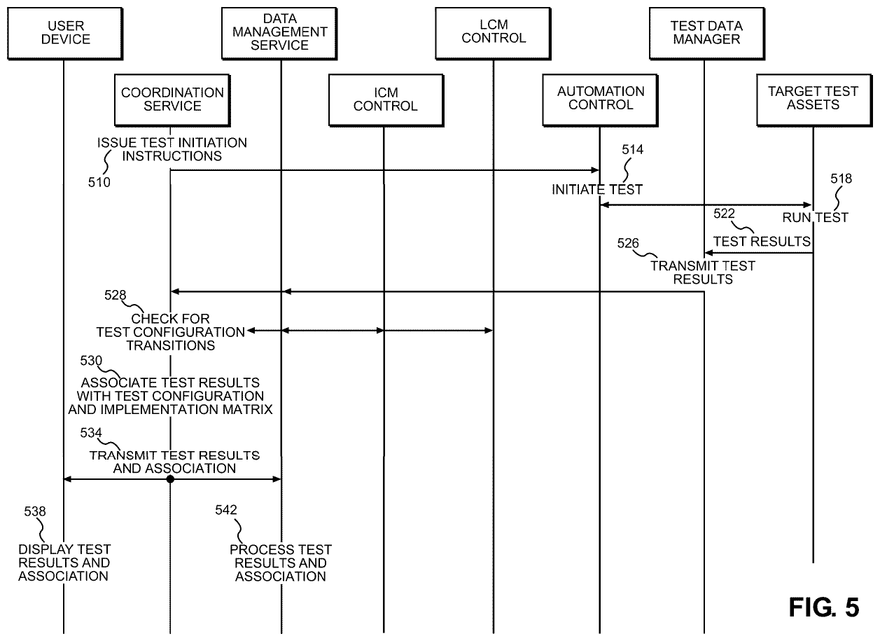

FIG. 5 depicts a sequence diagram of an example method for managing data for a testing system that includes test configuration-related information, according to one embodiment.

At 510, the coordination service may issue test initiation instructions to an automation control that cause the automation control to initiate testing of target assets at stage 514. Testing that may performed with testing systems and switches of the present disclosure may include testing all test assets together in a mission like environment. Examples of this may include a testing system corresponding to an aircraft, test including a simulation of the aircraft flying from one location to another. Such a test may involve every test asset working in conjunction which each other: from takeoff, where powertrain system pushes aircraft up; to a flight control system, rotating all rotors, starting forward flight, and doing all appropriate turns; to an avionics workbench controlling the aircraft to get to a different points along a flight path and be at certain altitudes at those points; to finally landing, which requires a test of the entire system of test assets as an aircraft in its entirety. However, prior to a point in the simulation that involves landing, engineers or lab operators may want to test certain in flight operations that do not involve the entire system. Such a test may involve flight controls systems when the aircraft is directed to go left, up, or right—a team of engineers may be interested in just seeing if actuators move in correct directions when the aircraft is directed in a particular direction.

At the completion of, or during, the execution of testing on the target test assets at 518, test results may be transmitted to the test data manager at 522. Test results may include any, some, or all of: an indication of whether or not a test was performed or configuration implemented; time values for any of a time to complete a test or configuration, or any sub-process thereof; functions or operations performed as part of the testing or configuring; and values of any performance metric related to the testing or configuring, including performance metrics applicable to any of the functions or operation performed by any test assets affected or involved in the testing or configuration.

In one example, the test data manager can request or direct data server controllers, such as the exemplary data server controllers of the testing system depicted in FIG. 1, to transmit test results as the those controllers receive the test results. Alternatively, the test data manager can direct the controllers to transmit testing results at the conclusion of any phase testing being performed, or according to a schedule independent of a completion of any test or test phase.

At 526, the test data manager may transmit test results to the data management service and the coordination services. In addition, the test data manager may temporarily store test results in a storage device of a switch or through a server at 526. In one example, the test data manager may itself define a storage device. The test results may be stored by the test data manager as a backup provision should issues arise with the data management service that involve a loss of data. Furthermore, the test data manager may control access to and direct the discarding of these stored test results. In another example, the test data manager may discard the test results as directed by the data management service.

At 528, the coordination service may access the ICM and/or LCM controls to determine if any configuration transitions were implemented in completing a test or configuration request.

Configuration transitions may relate to situations in which multiple teams submit test requests, at the same time or with little time in between, that involve common test assets which may be substituted with a utilization scheme for one request, but not for not for the other request. This may occur more and more as engineering teams increasingly use a capability provided by systems, devices, and methods described herein. That is, a capability to simultaneously test different test assets whether they are interconnected with different workbenches, provided in isolation, or incorporated as part of respective subsystems.

An example where a configuration transition may be implemented may include an initial version of a first test configuration including a sub-system that is also included in a second test configuration. The first test configuration may be able implement a utilization scheme to account for the sub-system no being available, whereas such an option is not available for the second test configuration. However, due the times when respective requests were received at a switch, an initial version of the first test configuration may include the sub-system. An LCM control or an ICM control may modify the initial first test configuration to include a utilization scheme such that both test configurations may be implemented simultaneously. Accordingly, information regarding the modification may be accessed or otherwise provided to the coordination and data management service by the ICM control and/or the LCM control at 528.

At 530, the coordination service may associate the test results with the test configuration and implementation matrix. In one embodiment, an association may include a comparison of aspects of implementations of a test configuration relative to different utilization schemes.

At 534, the coordination service may transmit test or configuration results, and any association determine at 530 to the user device and the data management service. Accordingly the user device may display, or otherwise convey, the test results and the association at 538.

At 542, the data management service may process the test results and the association received from the coordination service. Processing at 542 may include organizing, distributing, and/or assigning levels of accessibility to information received at 542.

FIG. 6 depicts a flowchart of an example method 600 for adding a test asset to a testing system, according to one embodiment.

At 610, a switch may receive an indication that a new test asset has or is being added to a testing system including the switch. As discussed herein throughout, a test asset may include a single test asset (e.g., LRU, powertrain dyno, actuator or actuation system), or a workbench including test assets, or a new string or system of operatively connected new test assets or new and existing test assets incorporated across multiple workbenches.

In one example, the indication received by the switch may be in the form of a new workbench being connected (via cable) to a port of the switch. In another example the indication may come by way of the switch receiving a request from the test asset or some form of a user interface for transmitting and/or receiving information with the test asset. In yet another example, an indication of an addition of a new test asset may be in the form of a communication from an existing workbench that the new test asset may be connecting to or being incorporated in.

At 620, a switch may obtain communication protocols and line replace unit information related to the new test asset. In one example, the switch may perform or otherwise have carried out, processes similar to those described as being included in the exemplary method of FIG. 2 at 220.

At 630, a switch may determine individual and system of systems configurations in which the new test asset may be incorporated. In one example, the switch may perform or otherwise have carried out, processes similar to those described as being included in the exemplary method of FIG. 3 at 340 and 355.

At 640, a switch may determine misconfigurations between the new test asset and individual test assets, workbenches, and even the switch. In the case of the switch, where a new test asset corresponds to a new workbench or even a new switch, the switch, via a coordination service, for example, may access all port information for the new component and determine if any port thereof cannot be connected to, either directly or through another asset or bench of the testing system.

In addition, regardless component type (e.g., individual test asset, workbench, switch, cable), the switch may perform processes similar to those discussed with respect to the exemplary method of FIG. 2 at 230.

At 650, a switch may update a respective implementation matrix to encompass the new test asset. This may include the switch carrying out some or all of the processes described with respect to the exemplary method of FIG. 2 at 240 and 250. In addition, the switch may manage the information represented by the implementation matrix, via a data management service, for example, to be processed as described herein and made accessible in a processed form: (A) for later use in the event of complications arising with a testing system including the switch; or (B) based on needs stemming from other activities such as establishing a new testing system, replicating a portion of an existing testing system for an expansion thereof, and the like.

One of ordinary skill in the art will recognize that an exemplary switch according to the present disclosure, coupled with the exemplary method 600 depicted in FIG. 6, may provide a testing system with a “plug and play” capability for adding or removing various types of test assets to or from the testing system.

Systems, devices, and methods described herein may provide significant benefits in the context test of testing systems, in particular system integrated labs for testing vehicles, such as aircrafts. Lab operators/engineering teams may plug and play which test assets and/or which features (hardware or software) of test assets or systems of test assets to work together, or be separated using a switch into which essentially all test assets are connected. Furthermore, all individual workbenches may be operatively connected to a switch via a coordination service as described herein. As a result, different test assets, workbenches, or systems of test assets may be added, taken away, or isolated from other test assets, workbenches, or systems of assets included in a testing system. Thus, entire systems may be tested, or certain test assets may be tested in a stand-alone manner that does not preclude testing of other assets or systems of assets.

Furthermore, individual systems can easily be integrated into a testing system such as the testing system 100 of FIG. 1, without a need to do a lab architecture redesign. Also, switching based on the operations of a coordination service, for example, may keep individuals from having to physically unplug and plug in connectors, reducing the chance of human error. In addition, systems, devices, and methods described herein may enable improved, near-optimal, or optimal utilization of lab capability—individual system tests do not require lock down of all other systems of, for example, a testing system corresponding to a vehicle, such as an aircraft. This may enable more engineering teams to work simultaneously.

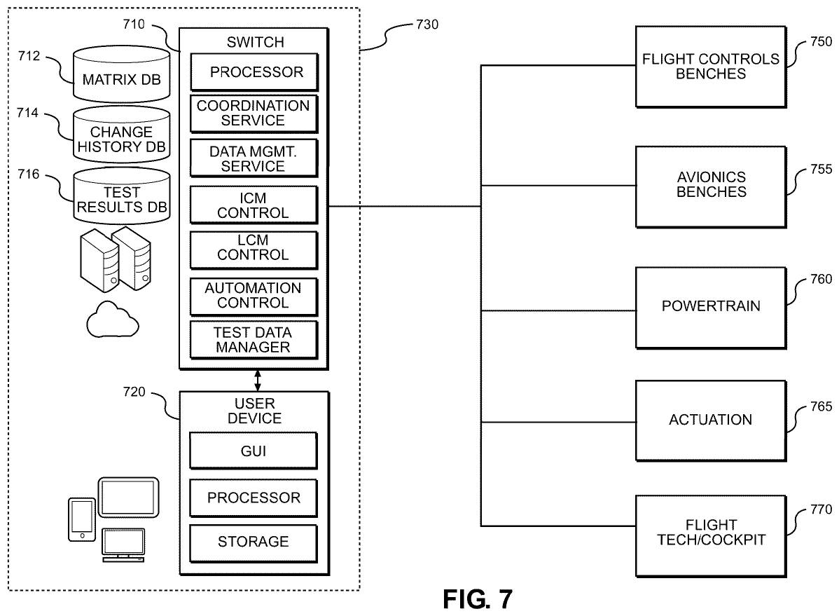

FIG. 7 depicts exemplary system components 700 for a testing system for vehicles, such as aircrafts, according to one embodiment. As shown the system components 700 may include a switch 710 and a user device 720, first, second, and third databases 712, 714, 716, and fight control, avionics, powertrain, actuation, and flight/cockpit workbenches 750, 755, 760, 765, 770 (hereafter referred to as “workbenches 750-770”), connected to or otherwise are in communication with, the switch 710.

In one example, each of the switch 710, the user device 720, first, second and third databases 712, 714, 716, and the workbenches 750-770 may be, include, or be comprised of one or more computing devices that may each include a processor, a memory storage, and a non-transitory computer-readable medium containing instructions that are executed by the processor. In addition, each of the exemplary system components 700 may be configured as a computing device for executing the processes according to exemplary embodiments of the present disclosure.

More specifically, each of the exemplary system components 700 discussed above may be an assembly of hardware including, for example: a data communication interface for packet data communication; a central processing unit (“CPU”), in the form of one or more processors, for executing program instructions; an internal communication bus; and a storage unit that may store data on a computer readable medium. In addition, each of the exemplary system components 700 may receive programming and data via network communications. Furthermore any and all of the exemplary system components 700 may have a memory (such as RAM) storing instructions for executing techniques presented herein, although the instructions may be stored temporarily or permanently within other modules of other system components. Each of the exemplary system components 700 may include input and output ports and/or a display to connect with input and output devices such as keyboards, mice, touchscreens, monitors, displays, etc. Various functions may be implemented in a distributed fashion on a number of similar combinations of system components, to distribute the processing load. Alternatively, systems constituted by the exemplary system components 700 may be implemented by appropriate programming of one computer hardware platform.

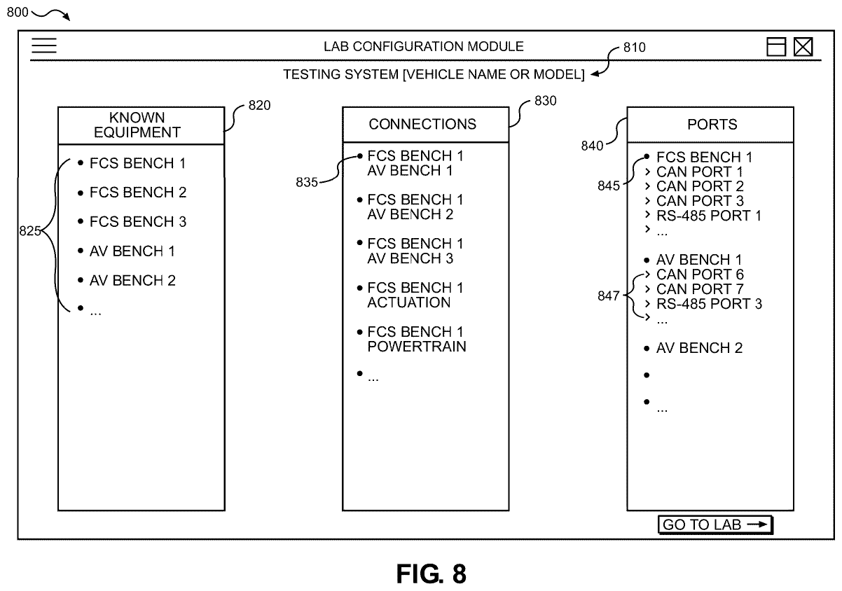

FIG. 8 depicts an example graphical user interface (“GUI”) 800 for a testing system used to perform the various methods described herein. The GUI 800 may display a system identifier 810 above equipment, connection, and port information tables 820, 830, 840. In one example the system identifier 810 may reveal a vehicle that corresponds to a testing system represented by the GUI 800.

As shown, the equipment information table 820 may include a first list 825 of test assets incorporated in the testing system of GUI 800. It is noted that the first list 825 is a list of workbenches included in the testing system of the GUI 800. It is noted that workbenches include combinations, systems, or subsystems of test assets but are themselves test assets. In one example, a selection of any of the test assets listed in the first list 825 may cause the GUI 800 to display a list of test assets incorporated in a workbench listed as a test asset in the equipment information table 820. In one example, the list of test assets may be displayed within the equipment information table 820. In another example, a second GUI (e.g., a page, a popup screen, etc.) may be displayed that includes the list of test assets and specification information regarding each (e.g., LRU information, connections to other test assets or workbenches).

As shown in FIG. 8, the connection information table 830 may include a second list 835 of items, each item including at least two test assets that are integrated or otherwise connected in the testing system of the GUI 800. In one example, a selection of any of the items in the second list 835 may cause the GUI 800 to display additional information about a connection represented by the selected item. In one example, additional information specific to each test asset may be displayed. In another example, information about the connection (e.g., type—cable or signal, communication protocol, status) between the test assets, as well as between the test assets and the switch (ports of the switch used for or with the connection selected).

The port information table 840 may include a third list 845 of test assets, and a sub-list 847 of ports belonging to each test asset. Selection of the any of the ports in any sub-list 847 may cause information regarding that port (e.g., type, other test asset connected thereto, status) within the port information table 840.

In one example, information included in the connection and/or port information tables 830, 840 may be accessed and populated from an implementation matrix maintained by a switch of the testing system of the GUI 800.

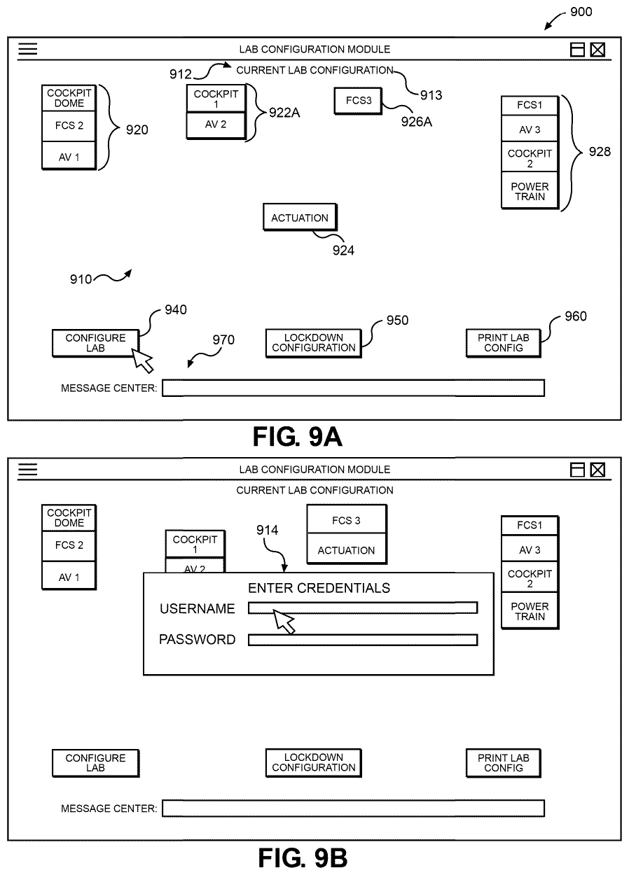

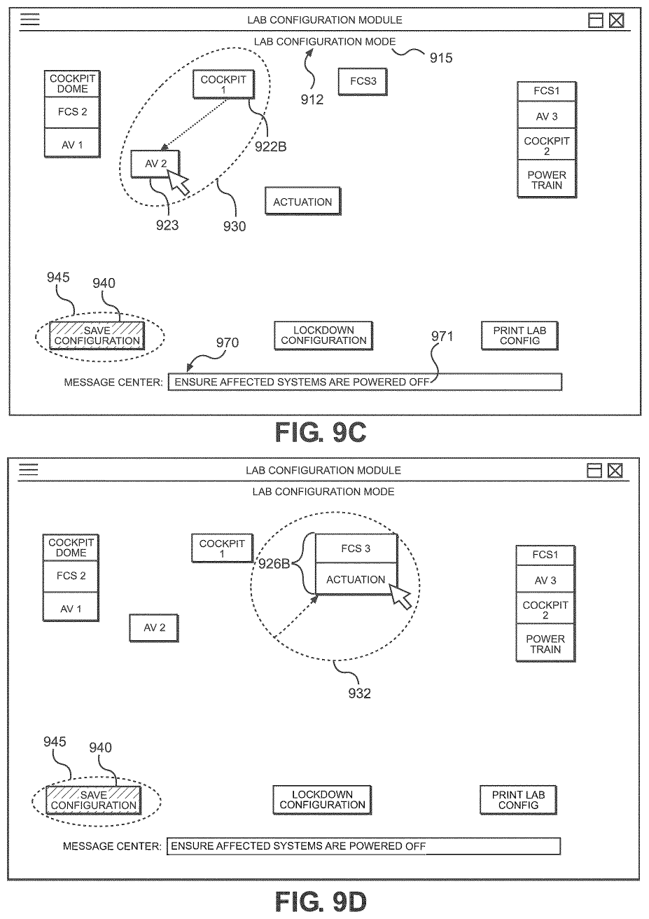

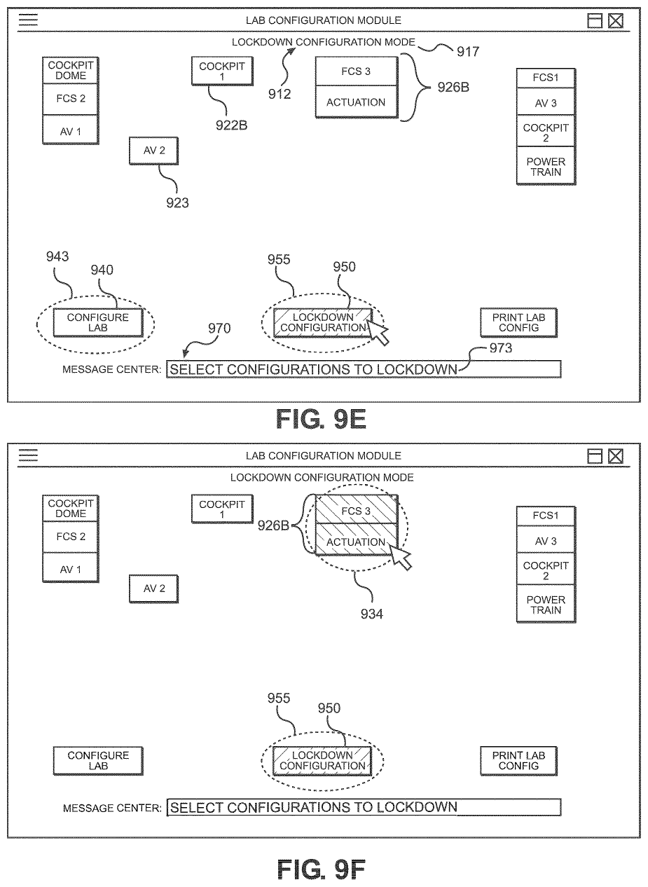

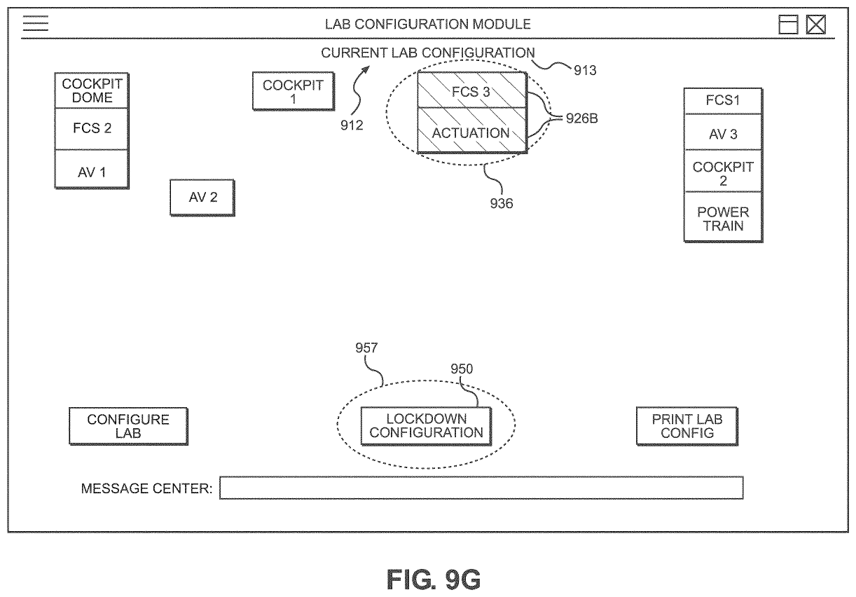

FIGS. 9A-9G depict an example GUI 900 for a testing system that may be used to perform various methods described herein.

FIG. 9A depicts the GUI 900 in a mode that provides a current configuration of test assets for a testing system. As shown, the GUI includes configure lab, lockdown configuration, and print lab configuration options 940, 950, 960 disposed above a message center 970 and below a lab display area 910. The lab display area 910 is disposed below a title bar 912 that may indicate a mode the GUI 900 is presently in. As indicated in the title bar 912 with a current lab configuration mode signal 913, the GUI 900 is in a current lab configuration display mode.

FIG. 9A depicts an exemplary representation of a lab configuration of tests asset for an exemplary testing system. More specifically a first test asset grouping 920, a second asset grouping 922A, and a third asset grouping 928 are displayed. In addition, a first stand-alone asset 924 (Actuation workbench) and a second stand-alone asset 926A (a third flight control system workbench or LRU (FCS3)) are also displayed.

As shown, the first test asset grouping 920 includes a cockpit dome LRU, a second flight control system workbench or LRU (FCS2), and a first avionics workbench or LRU (AV1).

The second asset grouping 922A includes a first cockpit LRU and a second avionics workbench or LRU (AV2).

The third grouping 928 includes a first flight control system workbench or LRU (FCS1), a third avionics workbench or LRU (AV3), and a second cockpit LRU.

According to an aspect of the present disclosure, selection of the configure lab option 940 will cause the GUI 900 to display an authorization entry form 914, as depicted in FIG. 9B. According to another aspect of the present disclosure, a user must provide valid credentials to enter into a lab configuration mode depicted in FIG. 9C. Entry and validation of a user credentials allow exemplary switches according to the present disclosure to log, track, or otherwise document an identification of a user with changes made to a lab configuration once the lab configuration mode is active. In one example, this logging of a user may be completed by an exemplary data management service as described herein. As a result, a switch may store or have access to information that subsequent users or engineering teams may use to obtain more information on a particular change to a lab configuration.

FIGS. 9C and 9D depict the GUI 900 in a lab configuration mode that may be presented once the credentials provided in the authorization entry form 914 are verified. The GUI 900 may display several indicators that the configuration mode is active. For example the title bar 912 may include the current lab configuration mode signal 913 and a save version 945 of the configure lab option 940 may be made active (as indicated with shading and/or text) as shown in FIG. 9C. In addition, a first message 971 in the message center 970 may advise of actions that must be taken with respect to an actual physical testing system and test assets thereof.

Exemplary systems, devices, and methods described herein may provide a platform in which a user may submit a change request through a GUI, such as the GUI 900, and a switch implementing or operatively tied to the GUI may carry out the requested configuration change to the actual testing system.

In one embodiment, a user may drag and drop an element representing a test asset away from a group of elements that represent a test asset grouping, like the second asset grouping 922A, for example, such that the selected and moved element is separated from all other elements (test assets) in the original asset grouping. In practice, such a use of the GUI 900 may be considered a configuration request as described in regards to the exemplary methods of FIGS. 3 and 4 at 310 and 410, respectively. Accordingly, once such a change is finalized by the selection of a save version 945 of the configure lab option 940, an exemplary switch according to the present disclosure implementing or otherwise operatively tied to the GUI 900, may perform the various processes of methods described herein. In particular, an action described above using the GUI 900 may cause a switch to determine a test configuration and switch be implemented according to that test configuration thereby changing an actual configuration of a testing system.

In addition to the save version 945 of the configure lab option 940, FIG. 9C also depicts a first preliminary configuration change 930 having been made by a user that selected and moved the second avionics workbench or LRU (AV2) out of the second grouping 922A. As shown, the first preliminary configuration change 930 provides third and fourth standalone test assets 922B, 923. This configuration is termed preliminary since it will not be implemented before, or at least not before, the save version 945 of the configure lab option 940 is selected. However, once saved, the first preliminary configuration change 930 may be considered a configuration request as described in regards to the exemplary methods of FIGS. 3 and 4 at 310 and 410, respectively.

Alternatively, or in addition to a previously saved configuration change, a user may drag and drop an element of the GUI 900 representing a single test asset or sub-system of test assets, to connect that element with another element representing a different test asset or sub-system of test assets. For example, FIG. 9D depicts a second preliminary configuration change 932 having been made with a user selecting, moving, and connecting the first stand-alone test asset 924 to the second stand-along test asset 926A. As shown, the second preliminary configuration change 932 provides a fourth asset grouping 926B.

As noted above, the save version 945 of the configure lab option 940 may be selected to save, and enable implementation of, the new configuration as defined by the second configuration change 932. Selection of the save version 945 of the configure lab option 940 may be followed by a popup that shows update status. A percentage complete may correspond to how much of the configuration has been in fact implemented within the testing system corresponding to GUI 900. Upon completion of the update, the current lab configuration mode signal 913 may be displayed in the title bar 912.

FIGS. 9E and 9F depict the GUI 900 in a lockdown configuration mode made active after a selection of the lockdown option 950. In one example, the lockdown configuration mode may only be made active once a user has provided credentials such as in FIG. 9B. However, in one example, this may be a separate authorization process, independent of any other authorization process previously implemented. That is, every time the configure lab option 940 or lockdown option 950 are selected, a user must satisfy an authorization process.

The GUI 900 may display several indicators that the lockdown mode is active. For example the title bar 912 may include a lockdown mode signal 917 and an active version 955 of the lockdown configuration option 955 may be displayed (with shading and/or text) as shown in FIGS. 9E and 9F. In addition, a second message 973 in the message center 970 may advise of actions that may be made with respect to the GUI 900.

In one example, a user may select test assets to lockdown, and successful selection of a test asset or group of test assets may be indicated by a changing of an appearance of a representation of the selected test assets. FIG. 9F provides an example. As shown, the fourth asset grouping 926B is depicted in a preliminary lock mode 934 (shaded as compared to its appearance in FIG. 9E) after having been selected.

User may select the active version 955 of the lockdown option 950 after all desired asset selections have been completed, and thus confirms that lockdown actions should follow according to the selections made. Successful registration of the test asset or group of test assets that will be locked down may be indicated by another change of appearance of the representation of the selected test assets. Unlocking a locked down assets may include a similar process of asset selection with a representation of a previously locked test asset reverting to an original state, as shown in FIG. 9A, for example.

FIG. 9G depicts a current configuration subsequent to completion of the configuration and lockdown activities represented in FIGS. 9D and 9F, respectively. As shown, the second asset grouping 926B is shown in a locked mode 936 with different shading than the preliminary lock mode 934 depicted in FIG. 9F.

In one example, the report option 960 may be selected and a report including information on the current lab configuration (test assets, connections, ports, configuration changes) may be generated. In one example, the system may generate a time-stamped .csv file for a report in response to a selection of the report option 960.

Program aspects of technology described herein may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments, various features are sometimes grouped together in a single embodiment, figure, or description thereof for the purpose of streamlining the disclosure and aiding in the understanding of one or more of the various aspects of present disclosure. This method of disclosure, however, is not to be interpreted as reflecting an intention that claimed subject matter requires more features than are expressly recited in each claim. Rather, as the following claims reflect, various aspects of the disclosure lie in less than all features of a single foregoing disclosed embodiment. Thus, the claims following the Detailed Description are hereby expressly incorporated into this Detailed Description, with each claim standing on its own as a separate embodiment of the present disclosure.

Furthermore, while some embodiments described herein include some but not other features included in other embodiments, combinations of features of different embodiments are meant to be within the scope of this disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the present disclosure. For example, functionality may be added or deleted from the block diagrams and operations may be interchanged among functional blocks. Steps may be added or deleted to methods described within the scope of the present disclosure.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of configuring a testing system, the method comprising:
receiving, with a switch, a request including one of an identification of a first test asset of the testing system for testing and a configuration request;
accessing a current configuration and a current test asset utilization of the testing system;
evaluating the current configuration based on the current test asset utilization and the request;
determining a test configuration based on the evaluation and an implementation matrix for the testing system; and
implementing the switch according to the test configuration,
wherein implementing the switch includes the switch connecting test assets according to the test configuration such that a first test for the first test asset or a configuration according to the configuration request is performed non-exclusively relative to a capability of the testing system to be implemented to test other test assets.

2. The method of claim 1, wherein the implementation matrix includes a misconfiguration specific to the testing system, and a utilization scheme, wherein the misconfiguration specifies at least two test assets of the testing system that cannot be operably coupled.

3. The method of claim 2, wherein the utilization scheme specifies at least two test assets that may be operably coupled by more than one series of operably coupled test assets.

4. The method of claim 1, further comprising modifying, with the switch, the test configuration to include a simulation of hardware of at least one test asset in the test configuration based on a current utilization of the hardware.

5. The method of claim 1, further comprising:
implementing, with the switch, the first test for the test asset of the request, and
implementing, with the switch, a second test for a second test asset at the same time as the first test.

6. The method of claim 5, wherein the first test asset includes a system of test assets.

7. The method of claim 5, wherein the first test asset is a single line replaceable unit included in a system of test assets that are incorporated in an actuation workbench or a powertrain workbench, and wherein the first test includes configuring the first test asset to be disconnected from the system of test assets.

8. The method of claim 7, wherein the first test includes stand-alone testing of the first test asset.

9. The method of claim 7, wherein the first test includes connecting the first test asset to a second test asset not included in the system of assets.

10. The method of claim 1, further comprising:
determining a configuration of the configuration request corresponds to a misconfiguration included in the implementation matrix;
issuing a notification that the configuration is invalid; and
displaying, with a computing device, the notification.

11. The method of claim 1, further comprising locking down a second test asset of the test system and implementing the first test of the first test asset, wherein the first test asset and the second test asset are incorporated in a first workbench.

12. The method of claim 11, further comprising implementing a second test of a third test asset incorporated in the first workbench during at least part of the implementing of the first test.

13. The method of claim 1, wherein the testing system corresponds to an aircraft, and wherein test assets of the testing system include an avionics workbench, a flight controls system workbench, and a powertrain workbench.

14. A testing system corresponding to a vehicle, the testing system comprising:
a plurality of workbenches, each workbench incorporating at least two test assets; and a
a switch operably coupled to the plurality of workbenches, the switch including:
a plurality of ports connected to the plurality of workbenches;
one or more processors; and
one or more computer readable media comprising instructions which, when executed by the one or more processors, cause the one or more processors to perform operations, the operations comprising:
receiving a request including one of an identification of a first test asset of the testing system for testing and a configuration request,
accessing a current configuration and a current test asset utilization of the testing system,
evaluating the current configuration based on the current test asset utilization and the request,
determining a test configuration based on the evaluation and an implementation matrix for the testing system,
implementing the switch according to the test configuration, and
tracking changes to a current configuration of the testing.

15. The testing system of claim 14, the operations, prior to the receiving, further comprising:
accessing the plurality of workbenches;
identifying misconfigurations between test assets of the testing system; and
incorporating the misconfigurations in the implementation matrix.

16. The testing system of claim 15, the operations, prior to the receiving, further comprising:
identifying utilization schemes for connecting the test assets across the plurality of workbenches,
wherein each of the utilization schemes specifies at least two test assets of the testing system that may be operably coupled by more than one series of operably coupled test assets.

17. The testing system testing system of claim 14, the operations further comprising modifying, with the switch, the test configuration to include a simulation of hardware of at least one test asset in the test configuration based on a current utilization of the hardware.

18. The testing system of claim 14, the operations further comprising:
locking down a second test asset of the test system and implementing a first test of the first test asset,
wherein the first test asset and the second test asset are incorporated in a first workbench of the plurality of workbenches.

19. A switch comprising:
a plurality of ports;
one or more processors; and
one or more computer readable media comprising instructions which, when executed by the one or more processors, cause the one or more processors to perform operations, the operations comprising:
receive a request including one of an identification of a first test asset of the testing system for testing and a configuration request;
access a current configuration and a current test asset utilization of the testing system;
evaluate the current configuration based on the current test asset utilization and the request;
determine a test configuration based on the evaluation and an implementation matrix for the testing system;
operate according to the test configuration; and
modify the test configuration to include a simulation of hardware of at least one test asset in the test configuration based on a current utilization of the hardware.

20. The switch of claim 19, wherein the plurality of ports includes at two of an Ethernet port, an RS-485 port, a CAN port, and an RS-422 port.
